(19) United States
(12) Patent Application Publication
(10) Pub. No.: US 2008/0242395 A1
(43) Pub. Date: Oct. 2, 2008

(54) GAMING MACHINE CAPABLE OF PERFORMING MINI GAME

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/020,677

(22) Filed: Jan. 28, 2008

Related U.S. Application Data
(60) Provisional application No. 60/907,258, filed on Mar. 27, 2007.

(51) Int. Cl. A63F 13/00

(52) U.S. Cl. 463/20

(57) ABSTRACT

A slot machine according to the present invention comprising: a display capable of arranging symbols thereto; and a controller, the controller programmed to conduct the processing of: (a) executing a normal game in which a game medium may be offered and the symbols are rearranged to the display; (b) executing a bonus game comprised of a single or a plurality of unit games in which the symbols are rearranged to the display, the bonus game is a game more advantageous to a player compared to the normal game; (c) executing a mini game corresponding to the symbols rearranged, out of a plurality of types of mini games in which a point value may be offered; and (d) increasing, in a case where the point value is consumed, an execution time period of the bonus game or the number of executions of the unit game in the bonus game.

### CROSS-REFERENCE TO RELATED APPLICATIONS

This application claims benefit of priority based on U.S. Provisional Patent Application No. 60/907,258 filed on Mar. 27, 2007. The contents of this application are incorporated herein by reference in their entirety.

### BACKGROUND OF THE INVENTION

1. Field of the Invention

The present invention relates to a gaming machine capable of executing a mini game.

2. Discussion of the Background

Conventionally, there has been a slot machine which executes a free game in the case of the establishment of a predetermined condition (for example, a specific symbol should be rearranged in a slot machine game) during a game. The free game is a game which can be executed without consuming a game medium. For example, as disclosed in AU 1972901-A, there is a slot machine which executes a free game as a sub game, in the case of the establishment of the predetermined condition (symbols are displayed in a specific manner) during a main game.

Further, in recent years, there has been a gaming machine which executes a mini game for a player to acquire a point value during an execution of a special game which is more advantageous to the player compared to a normal game, and allows the player to use the point value acquired in the mini game, in a bonus game (for example, a free game) executed thereafter.

It is an object of the present invention to provide a gaming machine capable of executing a mini game, thereby offering new entertainment.

The contents of AU 1972901-A is incorporated herein by reference in its entirety.

### SUMMARY OF THE INVENTION

According to the present invention, there is provided a gaming machine having the following structure.

Namely, the above-mentioned gaming machine comprises a display capable of arranging symbols thereto; and a controller. The controller is programmed to conduct the processing of: (a) executing a normal game in which a game medium may be offered and the symbols are rearranged to the display; (b) executing a bonus game comprised of a single or a plurality of unit games in which the symbols are rearranged to the display, the bonus game is a game more advantageous to a player compared to the normal game; (c) executing a mini game corresponding to the symbols rearranged, out of a plurality of types of mini games in which a point value may be offered; and (d) increasing, in a case where the point value is consumed, an execution time period of the bonus game or the number of executions of the unit game in the bonus game.

### BRIEF DESCRIPTION OF THE DRAWINGS

FIG. 1 is a flow chart illustrating a subroutine of game execution processing which is conducted by a mother board included in a slot machine according to a present embodiment.

FIG. 2 is a view illustrating exemplary correspondence between symbols and mini games, and exemplary upper limit values of the point value defined for the respective mini games.

FIG. 3 is a perspective view schematically illustrating the external structure of the slot machine according to the present embodiment.

FIG. 4 is a view illustrating an exemplary image which is displayed to a lower image display panel.

FIG. 5 is another view illustrating an exemplary image which is displayed to the lower image display panel.

FIG. 6 is another view illustrating an exemplary image which is displayed to the lower image display panel.

FIG. 7 is a schematic view illustrating symbol columns which are displayed to respective display blocks.

FIG. 8 is a block diagram illustrating the internal structure of the slot machine according to the present embodiment.

FIG. 9 is a flow chart illustrating a subroutine of mini-game execution processing in a case where Poker is executed as the mini game.

FIG. 10 is a flow chart illustrating a subroutine of mini-game execution processing in a case where Baccarat is executed as the mini game.

FIG. 11 is a flow chart illustrating a subroutine of bonus-game execution processing.

FIG. 12 is a view for explaining the relationship among a plurality of types of prizes, the probabilities of establishment of the respective prizes, and the number of payouts for the respective prizes, in a bonus game according to the present embodiment.

FIG. 13 is a flow chart illustrating a subroutine of symbol determination processing.

### DESCRIPTION OF THE EMBODIMENTS

An embodiment of the present invention will be described with reference to the drawings.

In the present embodiment, a slot machine game is executed, as a normal game in which a game medium (for example, a coin and a bill) may be offered. When a predetermined symbol is rearranged in this slot machine game, a mini game corresponding to the symbols rearranged is executed, out of a plurality of types of mini games. In the present embodiment, five types of card games corresponding to the symbols to be rearranged are provided as mini games. In each card game, a point value is offered to a player according to a win or a loss of the player and the player's established hand. Further, for the respective card games, different upper limits of the point value which may be offered are set. When the mini game ends, a bonus game, which is more advantageous to the player compared to the normal game, is executed. In the present embodiment, the bonus game is comprised of a free game which can be played without consuming the game medium. The free game is a slot machine game and, in the bonus game, a single or a plurality times of free games are executed. In the bonus game, it is possible to increase the number of free games by consuming a point value offered in the mini game.

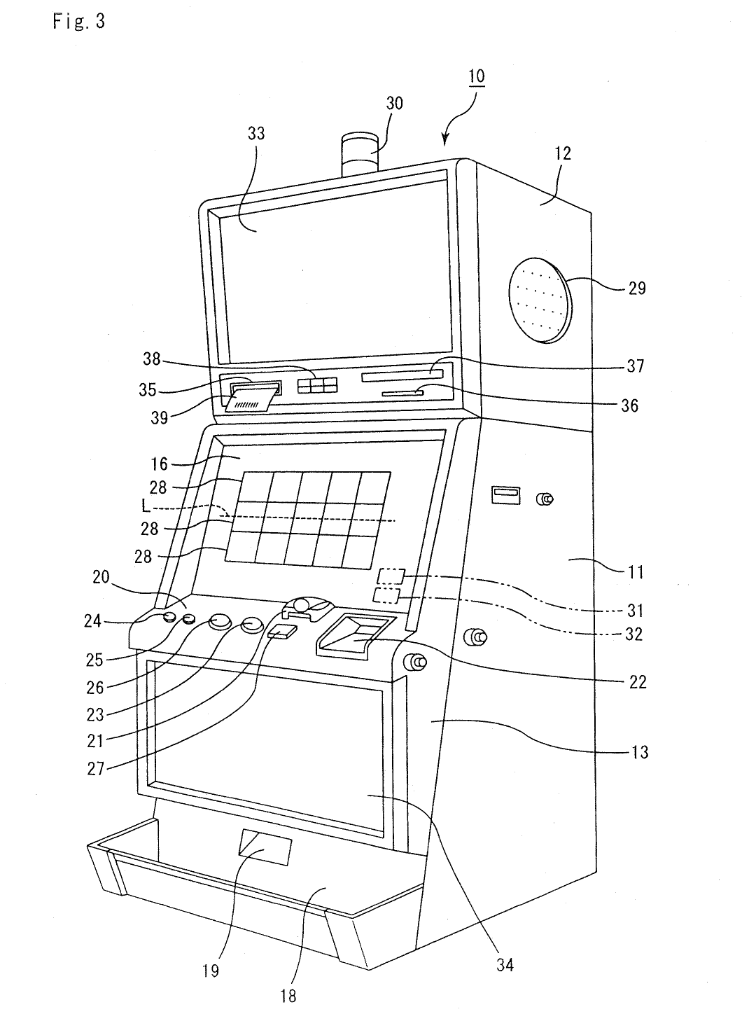

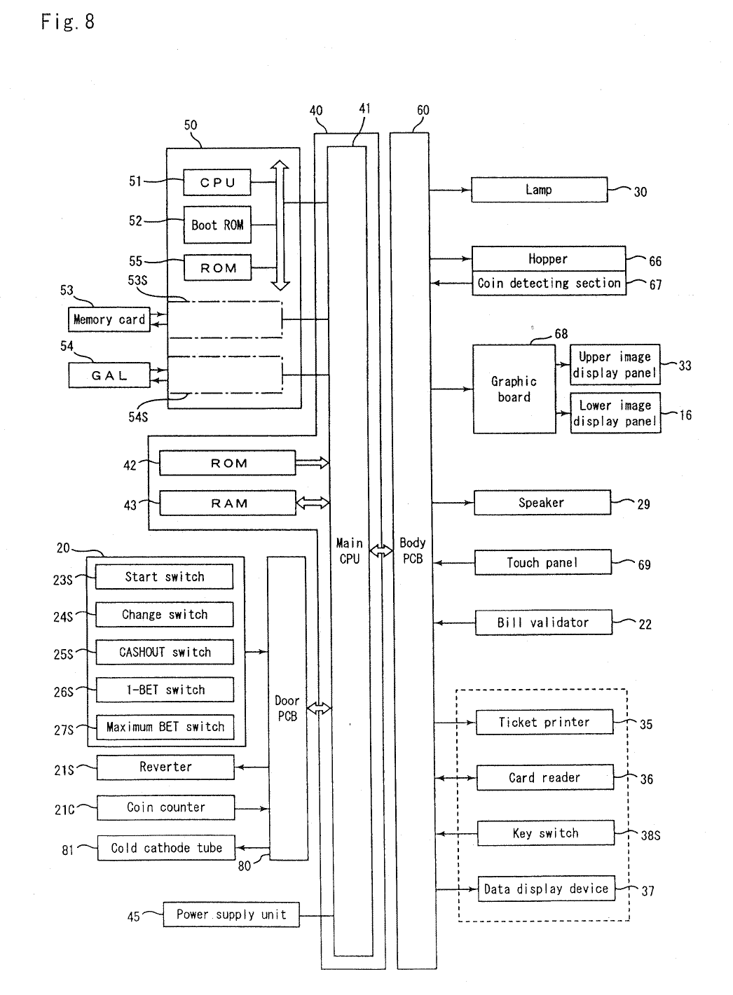

First, there will be described game execution processing which is conducted by a mother board 40 (see FIG. 8) included in a slot machine 10 (see FIG. 3) according to the present embodiment.

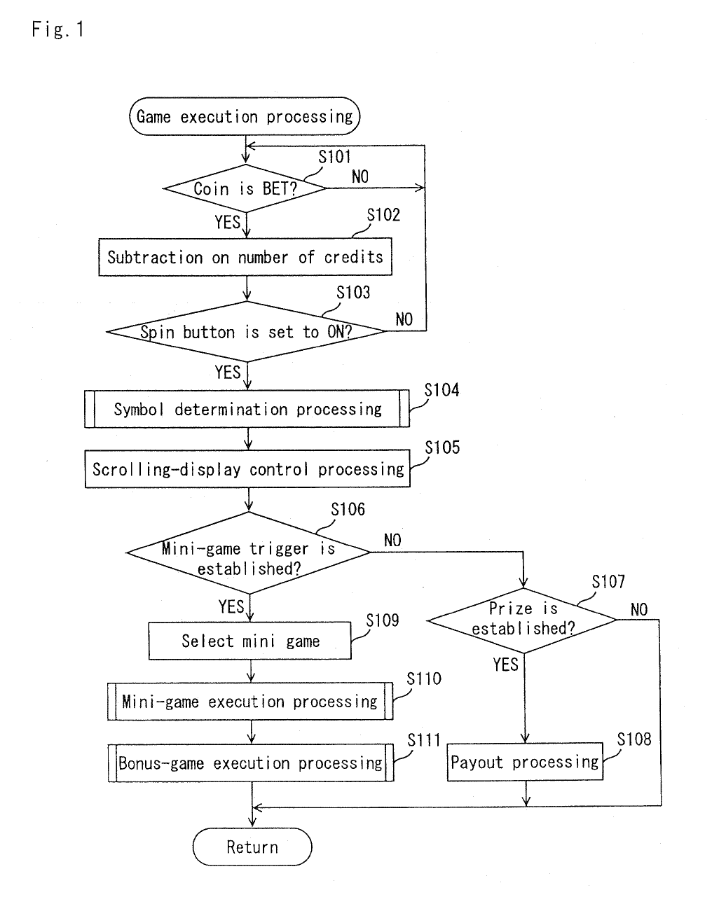

FIG. 1 is a flow chart illustrating a subroutine of the game execution processing which is conducted by the mother board included in the slot machine according to the present embodiment.

First, in step S101, a main CPU 41 (see FIG. 8) included in the mother board 40 determines whether or not a coin is BET. In this processing, the main CPU 41 determines whether or not to have received an input signal which is to be outputted from a 1-BET switch 26S (see FIG. 8) when a 1-BET button 26 (see FIG. 3) is operated, or an input signal which is to be outputted from a maximum BET switch 27S (see FIG. 8) when a maximum BET button 27 (see FIG. 3) is operated. When determining that no coin is BET, the main CPU 41 returns the processing to step S101.

On the other hand, when determining in step S101 that the coin is BET, the main CPU 41 conducts processing for performing a subtraction on the number of credits stored in a RAM 43 (see FIG. 8), according to the number of coins BET, in step S102. Further, when the number of coins BET is larger than the number of credits stored in the RAM 43, the main CPU 41 returns the processing to step S101, without conducting the processing for performing a subtraction on the number of credits stored in the RAM 43. Further, when the number of coins BET exceeds the upper limit of the number of coins that can be BET on a single game (fifty coins in the present embodiment), the main CPU 41 shifts the processing to step S103, without conducting the processing for performing a subtraction on the number of credits stored in the RAM 43.

Next, in step S103, the main CPU 41 determines whether or not a spin button 23 (see FIG. 3) is set to ON. In this processing, the main CPU 41 determines whether or not to have received a signal which is to be outputted from a start switch 23S (see FIG. 8) when the spin button 23 is pressed.

When determining that the spin button 23 is not set to ON, the main CPU 41 returns the processing to step S101.

Further, when the spin button 23 has not been set to ON (for example, when a command to end the game is inputted without setting the spin button 23 to ON), the main CPU 41 cancels the result of the subtraction in step S102.

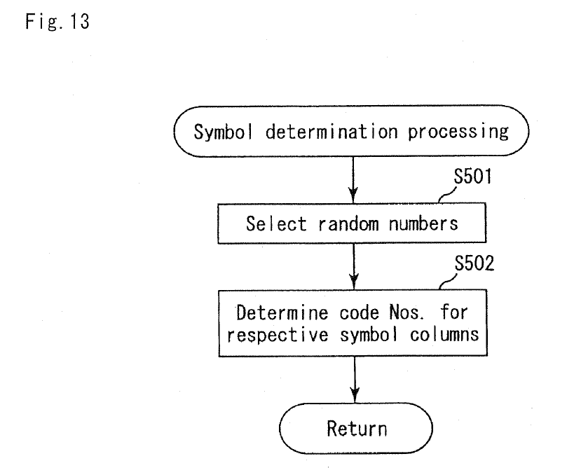

On the other hand, when determining in step S103 that the spin button 23 has been set to ON, the main CPU 41 conducts symbol determination processing in step S104. In this symbol determination processing, the main CPU 41 executes a symbol determination program stored in the RAM 43 to determine a code No. of the symbol in stopping. Thereby, a combination of symbols to be rearranged is determined. This processing will be specifically described later with reference to FIG. 13. Further, in the present embodiment, there will be described a case where the combination of symbols to be rearranged is determined so as to determine a single prize out of a plurality of types of prizes. However, in the present invention, for example, a single prize selected out of a plurality of types of prizes may be determined first, and thereafter, the combination of symbols to be rearranged may be determined based on the above-mentioned prize.

Next, in step S105, the main CPU 41 conducts scrolling-display control processing.

This processing is processing for starting scrolling display of symbols and then stopping the scrolling display in respective display blocks 28 (see FIG. 3) such that the combination of symbols determined in step S104 is rearranged along the winning line L.

Next, in step S106, the main CPU 41 determines whether or not a mini-game trigger has been established. Namely, the main CPU 41 determines whether or not five same symbols corresponding to any one of the five types of mini games have been rearranged along the winning line L (see FIG. 3).

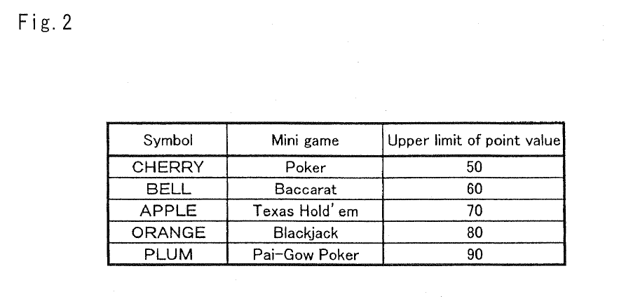

Here, there will be described the correspondence between the symbol and the mini game. FIG. 2 is a view illustrating exemplary correspondence between the symbols and the mini games, and exemplary upper limit values of the point value defined for the respective mini games. As illustrated in FIG. 2, there are five types of mini games: Poker; Baccarat; Texas Hold'em; Blackjack; and Pai-Gow poker, which are all card games. In poker and Texas Hold'em, the point value to be offered to the player is determined based on the established hands. In Baccarat, the point value is determined based on whether or not the player wins. In Blackjack and Pai-Gow poker, the point value is determined based on the win or the loss of the player against a banker.

When five predetermined symbols are rearranged along the winning line L, the mini game corresponding to the symbols is executed. For example, when five symbols of “CHERRY” are rearranged, Poker is executed, and when five symbols of “BELL” are rearranged, then Baccarat is executed.

Further, for each of the mini games, an upper limit of the point value which may be offered is set. For example, in Poker, a maximum point value which may be offered is fifty.

When determining, in step S106, that the mini-game trigger has not been established, the main CPU 41 determines whether or not a prize has been established in step S107. The prize in step S107 is a prize other than the mini-game trigger. Exemplary prizes other than the mini-game trigger include a prize based on five same symbols of “JACKPOT 7,” “BLUE 7,” or “STRAWBERRY,” which have been rearranged along the winning line L, and a prize based on a specific combination of two or more types of symbols which have been rearranged along the winning line L. The specific combination is predetermined combination of specific symbols, out of combinations of symbols which may be established. In the present embodiment, the specific combinations are three types of combinations, which are combinations of alternately arranged symbols of “BELL” and “CHERRY,” such as “BELL,” “CHERRY,” “BELL,” “CHERRY,” “BELL,” a combination of three symbols of “BELL” sandwiched by two symbols of “STRAWBERRY,” such as “STRAWBERRY,” “BELL,” “BELL,” “BELL,” “STRAWBERRY,” and combinations of three symbols of “BELL” and two symbols other than “BELL.”

When determining, in step S107, that a prize has been established, the main CPU 41 pays out the coin according to the number of coin-ins and the prize (step S108). In the case of accumulating the coin, the main CPU 41 conducts processing for adding the number of credits stored in the RAM 43. On the other hand, in the case of paying out the coin, the main CPU 41 transmits a control signal to a hopper 66 (see FIG. 8) to pay out the predetermined number of coins.

The processing for conducting steps S101 to S108 corresponds to processing for executing the normal game according to the present invention.

When determining, in step S106, that the mini-game trigger has been established, the main CPU 41 determines a mini game to be executed, based on the symbols rearranged along the winning line L in step S109.

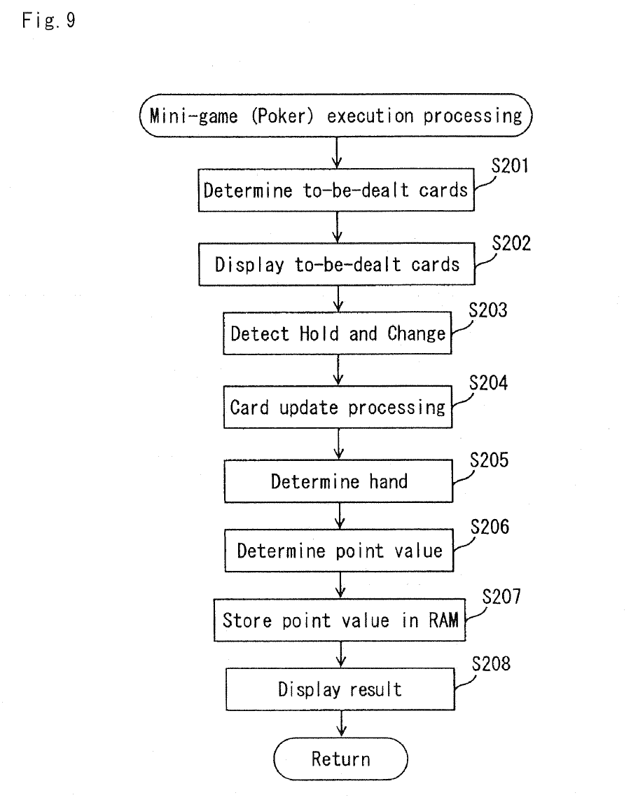

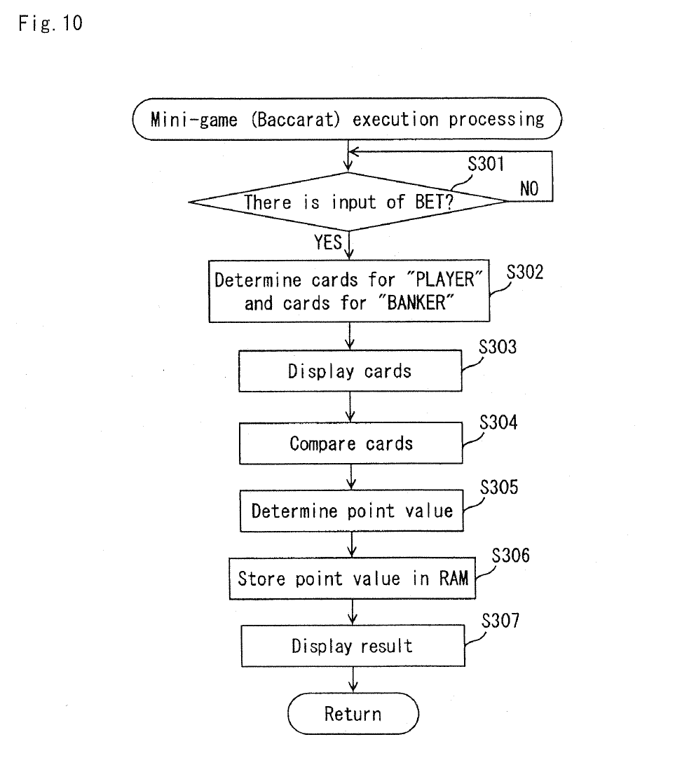

Next, in step S110, the main CPU 41 reads a program for executing the mini game from the RAM 43, and executes mini-game execution processing. In the mini-game execution processing, processing for executing the card game determined in step S109 is conducted. This processing will be specifically described later with reference to FIGS. 9 and 10.

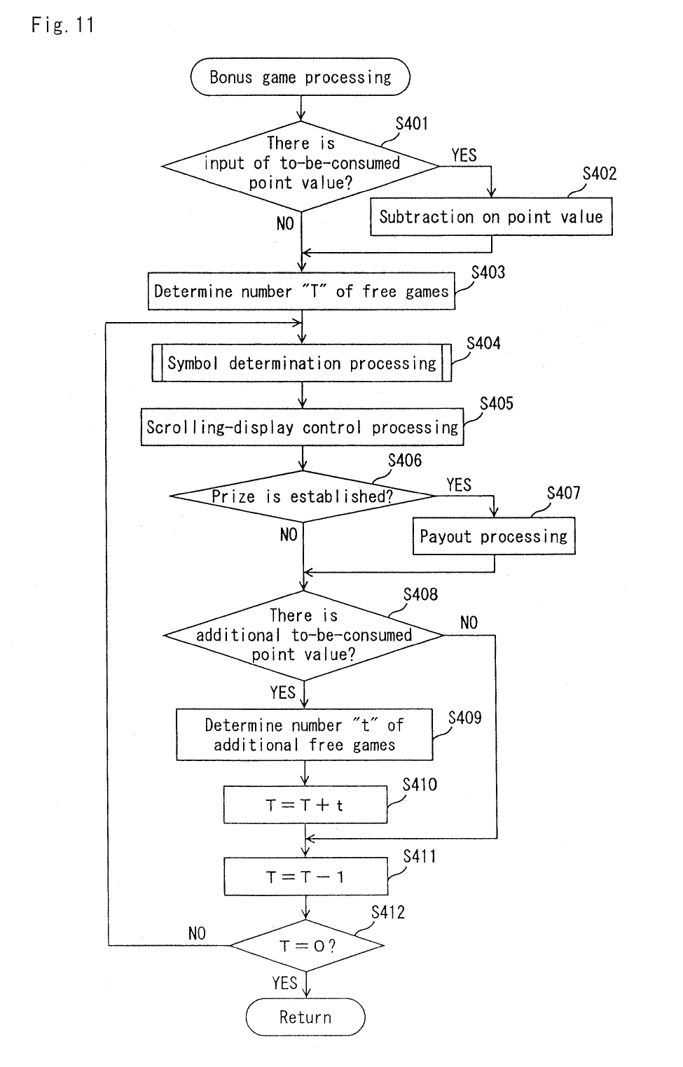

Next, in step Sill, the main CPU 41 reads a program for executing the bonus game from the RAM 43 and conducts bonus game execution processing. The bonus game execution processing is processing for executing the free game according to the consumed point value, which will be specifically described later with reference to FIG. 11.

When conducting the processing in step S108 or step Sill, or when determining, in step S107, that no prize has been established (when it is determined that no-winning has occurred), the main CPU 41 ends the present subroutine.

Next, there will be described the slot machine 10 according to the present embodiment.

FIG. 3 is a perspective view schematically illustrating the external structure of the gaming machine according to the present embodiment.

In the present embodiment, the slot machine 10 is a video slot machine. However, in the present invention, the slot machine is not limited to the video slot machine. Examples thereof may include a rotational-reel type slot machine. In the slot machine 10, a coin, a bill or electronic valuable information corresponding to those is used, as a game medium. However, in the present invention, the game medium is not particularly limited. Examples of the game medium may include a medal, a token, electronic money and a ticket. It is to be noted that the ticket is not particularly limited, and examples thereof may include a ticket with a barcode as described later.

The slot machine 10 comprises a cabinet 11, a top box 12 installed on the upper side of the cabinet 11, and a main door 13 provided at the front face of the cabinet 11.

At the front side of the main door 13, there is provided the lower image display panel 16. The lower image display panel 16 is provided with a transparent liquid crystal display panel to which a variety of information concerning the game, an effect image and the like are displayed during the game. The lower image display panel 16 corresponds to a display according to the present invention. The lower image display panel 16 included in the slot machine 10 according to the present embodiment comprises a transparent liquid crystal display panel which displays fifteen display blocks 28 in five columns and three rows, when executing the normal game and the bonus game. A single symbol is displayed to each display block 28. Namely, three symbols are displayed along each symbol column. Further, on the lower image display panel 16, there is formed a single winning line L horizontally crossing over the five display blocks 28 displayed along the center row. The winning line L is for determining a combination of symbols. When the combination of symbols rearranged along the winning line L is the predetermined combination, coins in number corresponding to that combination and the number of coin-ins (the number of BETs) are paid out.

In the lower image display panel 16, there are provided a number-of-credits display section 31 and a number-of-payouts display section 32. To the number-of-credits display section 31, an image indicating the number of credited coins is displayed. The number-of-payouts display section 32 displays an image indicating the number of coin-outs when the combination of symbols rearranged along the winning line L is a predetermined combination.

Further, in the present invention, for example, it may be possible to provide a configuration such that there are formed a plurality of winning lines L crossing horizontally or diagonally over the fifteen display blocks 28, and the winning lines L in number according to the number of inserted coins are verified. Further, when the combination of symbols stop-displayed along the verified winning line L is the predetermined combination, coins are paid out in number according to the combination.

Further, although not illustrated, a touch panel 69 is provided at the front face of the lower image display panel 16. The player can operate the touch panel 69 to input a variety of commands.

Below the lower image display panel 16, there are provided a control panel 20 comprised of a plurality of buttons 23 to 27 with each of which a command according to game progress is inputted by the player, a coin receiving slot 21 through which a coin is accepted into the cabinet 11, and a bill validator 22.

The control panel 20 is provided with a spin button 23, a change button 24, a CASHOUT button 25, a 1-BET button 26, and a maximum BET button 27. The spin button 23 is used for inputting a command to start scrolling display on the fifteen display blocks 28. The change button 24 is used for making a request of a staff in the recreation facility for exchange. The CASHOUT button 25 is used for inputting a command to pay out credited coins to a coin tray 18.

The 1-BET button 26 is used for inputting a command to bet one coin, out of the credited coins, on the game. The maximum BET button 27 is used for inputting a command to bet the maximum number of coins that can be bet on one game (fifty coins in the present embodiment), out of the credited coins, on the game.

The bill validator 22 not only discriminates a regular bill from a false bill, but also accepts the regular bill into the cabinet 11. Further, the bill validator 22 may be configured so as to be capable of reading a later-described ticket 39 with a barcode. At the lower front of the main door 13, namely below the control panel 20, there is provided a belly glass 34 on which a character or the like of the slot machine 10 is drawn.

On the front surface of the top box 12, there is provided an upper image display panel 33. The upper image display panel 33 is provided with a liquid crystal panel to display, for example, an image representing introduction of contents of a game, and explanation of a rule of the game.

Further, on the top box 12, a speaker 29 is provided. Under the upper image display panel 33, there are provided a ticket printer 35, a card reader 36, a data display device 37 and a key pad 38. The ticket printer 35 prints on a ticket a barcode as coded data of the number of credits, a date, identification number of the slot machine 10, and the like, and outputs the ticket as a ticket 39 with a barcode. The player can have another slot machine read the ticket 39 with a barcode to play a game thereon, or exchange the ticket 39 with a barcode with a bill and the like at a predetermined place in the recreation facility (e.g. a cashier in a casino).

The card reader 36 reads data from the smart card and writes data into the smart card. The smart card is a card owned by the player and stores, for example, data for identifying the player and data on the history of games played by the player. The smart card may store data corresponding to the coin, the bill or the credit. Also, in place of the smart card, a magnetic stripe card may be employed. The data display device 37 is comprised of a fluorescent display and the like, and displays, for example, data read through the card reader 36 or data inputted by the player through the key pad 38. The key pad 38 is used for inputting a command and data relating to issuance of a ticket and the like, and for inputting the point value to be consumed in the bonus game.

Next, there will be described an image displayed to the lower image display panel.

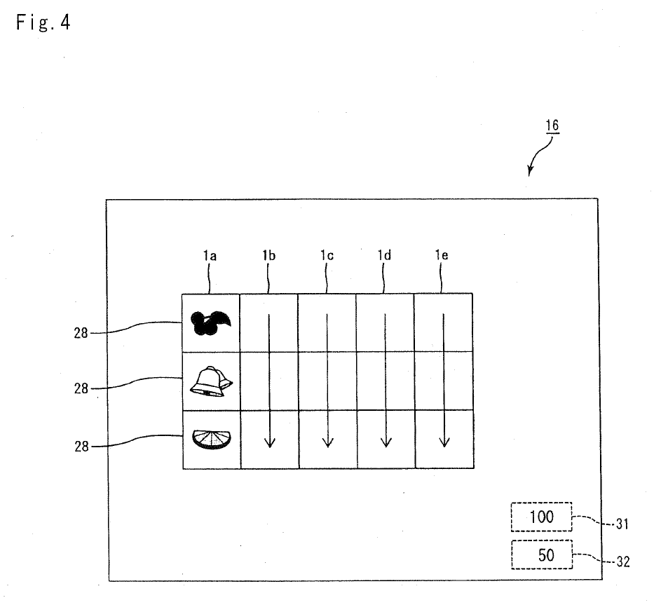

FIGS. 4, 5, and 6 are views illustrating exemplary images which are displayed to the lower image display panel.

FIG. 4 is an exemplary image which is displayed to the lower image display panel 16 when the normal game and the bonus game are executed.

As illustrated in FIG. 4, at a center portion of the lower image display panel 16, there are displayed fifteen display blocks 28 in five columns and three rows. The display blocks 28 form five display block columns 1a to 1e. Symbols are rearranged to the display block column 1a out of these, while to the other four display block columns 1b to 1e, symbols are scroll-displayed. In the figure, downward arrows indicate symbols being scroll-displayed thereto. Further, at a lower right portion of the lower image display panel 16, there are provided the number-of-credits display section 31 and the number-of-payouts display section 32.

Next, there will be described an image displayed to the lower image display panel 16 when the mini game is executed. Here, there will be described a case where Poker and Baccarat are executed as the mini game.

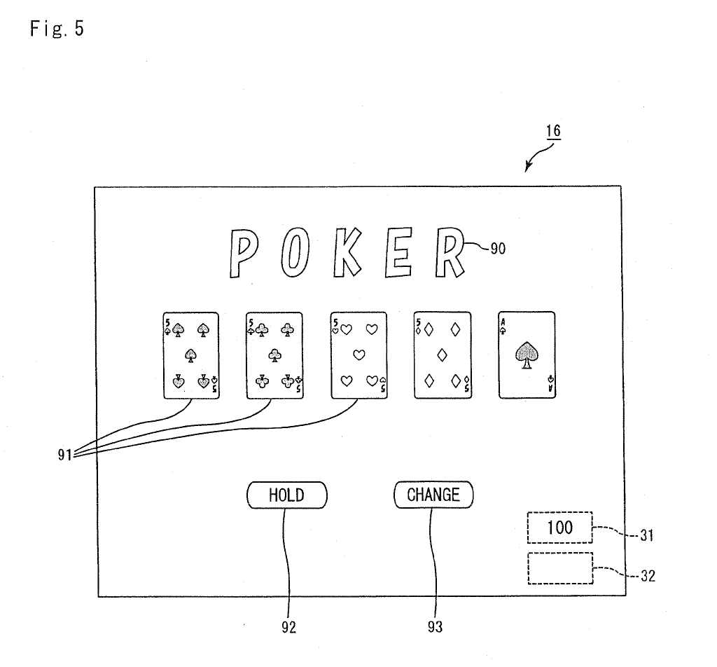

FIG. 5 is an exemplary image which is displayed to the lower image display panel 16 when Poker is executed.

As illustrated in FIG. 5, at the upper portion of the lower image display panel 16, there is displayed a letter image 90 describing “POKER” indicating that poker will be executed. Below the letter image 90, there are displayed five card images 91 indicating five playing cards. Further, below the card images 91, there are provided a Hold button 92 for inputting a choice of Hold and a Change button 93 for inputting a choice of Change. Here, “Hold” means keeping the displayed card without changing it, while “Change” means exchanging the displayed card with a different card. The card to which an input of Change has been conducted is exchanged with the different card. The player can hold the card by selecting the card that he or she desires to hold through the touch panel 69 and then operating the Hold button 92 through the touch panel 69. Similarly, the player can change the card by selecting the card that he or she desires to change through the touch panel 69 and then operating the Change button 93 through the touch panel 69.

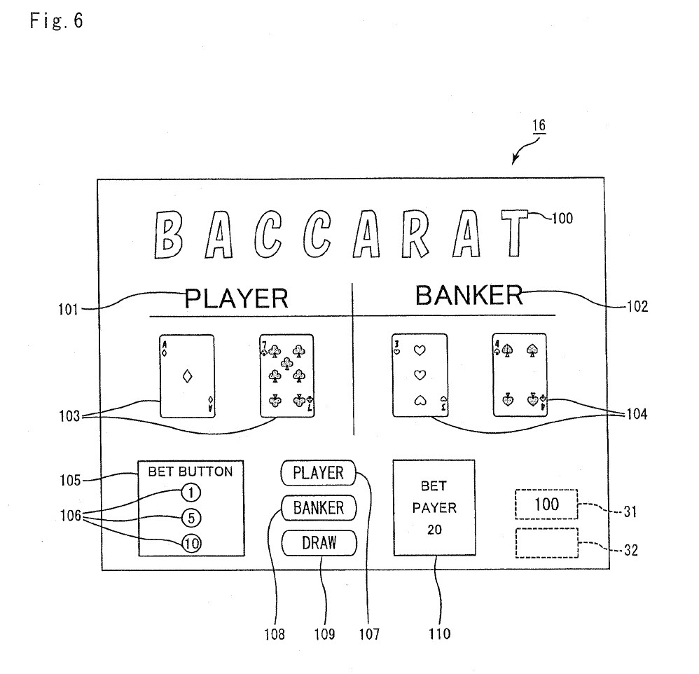

FIG. 6 illustrates an exemplary image which is displayed to the lower image display panel 16 during the execution of Baccarat.

As illustrated in FIG. 6, at an upper portion of the lower image display panel 16, there is displayed a letter image 100 describing “BACCARAT” indicating that Baccarat will be executed. Below the letter image 100, there are displayed a letter image 101 describing “PLAYER” and a letter image 102 describing “BANKER.” Below the letter image 101 describing “PLAYER,” there are displayed card images 103 indicating the cards dealt to “PLAYER.” Further, below the letter image 102 describing “BANKER,” there are displayed card images 104 indicating the cards dealt to “BANKER.” Further, on a lower left side of the lower image display panel 16, there is provided a BET button display section 105. To the BET button display section 105, there are displayed BET buttons 106 for inputting the number of BETs. The player can input the number of BETs by operating the BET buttons 106 through the touch panel 69. On the right side of the BET button display section 105, there are provided a “PLAYER” button 107 for making the BET on “PLAYER,” a “BANKER” button 108 for making the BET on “BANKER,” and a “DRAW” button 109 for making the BET on “DRAW.” Further, on the right side of these buttons, there is provided a number-of-BETs display section 110 for displaying the number of BETs. FIG. 6 indicates that twenty coins have been BET on “PLAYER.”

Next, there will be described the symbol column which is displayed when the normal game and the bonus game are executed.

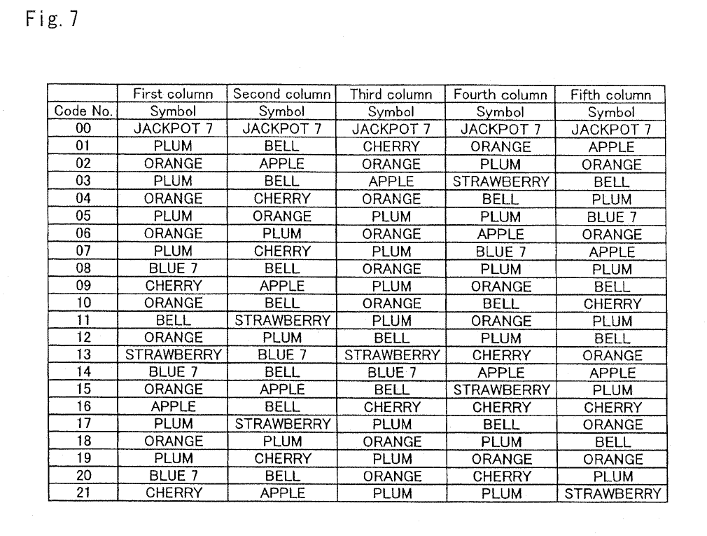

FIG. 7 is a schematic view illustrating the symbol columns which are displayed to the respective display blocks.

As described above, to the lower image display panel 16, there are displayed the fifteen display blocks 28 in five columns and three rows. A single symbol is displayed to each display block 28.

As illustrated in FIG. 7, an array of 22 symbols in total, each of which has a code number out of “00” to “21,” is scrolled along each of the five symbol columns in the respective display blocks 28. Each array of symbols is comprised of a combination of symbols: “JACKPOT 7,” “BLUE 7,” “BELL,” “STRAWBERRY,” “PLUM,” “CHERRY,” “ORANGE,” and “APPLE.”

In the normal game, “CHERRY,” “BELL,” “APPLE,” ORANGE,” and “PLUM” are mini-game triggers (symbols to make a shift to the mini game). When five same symbols of “CHERRY,” “BELL,” “APPLE,” ORANGE,” or “PLUM” are rearranged along the winning line L, the player can make the shift to the mini game.

When the spin button 23 is pressed to start the game after the 1-BET button 26 or the maximum BET button 27 is pressed, symbols are scroll-displayed in the downward direction, to the respective display blocks 28. Then, after the elapse of a predetermined time period, symbols are rearranged. Further, various types of prizes are predetermined based on the combinations of respective symbols. When a combination of symbols corresponding to a prize stops along the winning line L, the number of coin-outs corresponding to the prize is added to the credit owned by the player. Further, in a case where the mini-game trigger is established in the normal game, the mini game is generated.

Further, in the present embodiment, there will be described a case where symbols are automatically rearranged after the elapse of the predetermined time period since the start of scrolling display of symbols to the display blocks 28. However, the present invention is not limited to the case, and the slot machine 10, for example, may be provided with a stop button and symbols may be rearranged when the above-mentioned stop button is pressed.

FIG. 8 is a block diagram illustrating the internal structure of the slot machine illustrated in FIG. 3.

A gaming board 50 is provided with a CPU (Central Processing Unit) 51, a ROM 55, and a boot ROM 52 which are interconnected to one another by an internal bus, a card slot 53S corresponding to a memory card 53, and an IC socket 54S corresponding to a GAL (Generic Array Logic) 54.

The memory card 53 is comprised of a nonvolatile memory such as CompactFlush (registered trade mark), and stores a game program. The game program includes a symbol determination program. The symbol determination program is a program for determining a symbol (code No. corresponding to the symbol) to be rearranged along the winning line L.

Further, the card slot 53S is configured so as to allow the memory card 53 to be inserted thereinto or ejected therefrom, and is connected to the mother board 40 by an IDE bus. Therefore, the type and contents of a game played on the slot machine 10 can be changed by ejecting the memory card 53 from the card slot 53S, and writing another game program into the memory card 53, and then inserting the memory card 53 into the card slot 53S. The game program includes a program relating to progression of the game. Further, the game program includes image data and sound data to be outputted during the game.

The CPU 51, the ROM 55, and the boot ROM 52, which are interconnected to one another by the internal bus, are connected to the mother board 40 through a PCI bus. The PCI bus not only conducts signal transmission between the mother board 40 and the gaming board 50, but also supplies electric power from the mother board 40 to the gaming board 50.

The mother board 40 is configured using a commercially available general-purpose mother board (a print wiring board on which fundamental components of a personal computer are mounted), and comprises the main CPU 41, a ROM (Read Only Memory) 42, and a RAM (Random Access Memory) 43. The mother board 40 corresponds to a controller according to the present invention.

The ROM 42 is comprised of a memory device such as a flash memory, and stores a program such as a BIOS (Basic Input/Output System) executed by the main CPU 41 and permanent data. When the BIOS is executed by the main CPU 41, processing for initializing a predetermined peripheral device is conducted, concurrently with start of processing for loading the game program stored in the memory card 53 through the gaming board 50. Also in the present invention, the ROM 42 may or may not be data rewritable one.

The RAM 43 stores data and a program to be used at the time of operation of the main CPU 41. Also, the RAM 43 is capable of storing a game program.

Also, the RAM 43 stores data of the number of credits, the number of coin-ins and coin-outs in a single game, and the like.

Further, the mother board 40 is connected with a later-described body PCB (Printed Circuit Board) 60 and a door PCB 80 through respective USBs. Further, the mother board 40 is connected with a power supply unit 45.

The body PCB 60 and the door PCB 80 are connected with an equipment and a device, which generate an input signal to be inputted into the main CPU 41, and an equipment and a device, operations of which are controlled by a control signal outputted from the main CPU 41. The main CPU 41 executes the game program stored in the RAM 43 based on the input signal inputted into the main CPU 41, and thereby conducts the predetermined arithmetic processing and stores the result thereof into the RAM 43, or transmits a control signal to each equipment and device as processing for controlling each equipment and device.

The body PCB 60 is connected with a lamp 30, a hopper 66, a coin detecting section 67, a graphic board 68, a speaker 29, a touch panel 69, a bill validator 22, a ticket printer 35, a card reader 36, a key switch 38S, and a data display device 37. The lamp 30 is lighted in a predetermined pattern based on a control signal outputted from the main CPU 41.

The hopper 66 is installed inside the cabinet 11, and pays out a predetermined number of coins based on the control signal outputted from the main CPU 41, from the coin payout exit 19 onto the coin tray 18. The coin detecting section 67 is provided inside the coin payout exit 19, and outputs an input signal to the main CPU 41 in the case of detecting payout of the predetermined number of coins from the coin payout exit 19.

The graphic board 68 controls image display to the upper image display panel 33 and the lower image display panel 16 based on the control signal outputted from the main CPU 41. To the respective display blocks 28 of the lower image display panel 16, a background color determined by selecting a random number is displayed, and also symbols are scroll-displayed or stop-displayed. The number-of-credits display section 31 of the lower image display panel 16 displays the number of credits stored in the PAM 43. Further, the number-of-payouts display section 32 of the lower image display panel 16 displays the number of coin-outs.

The graphic board 68 comprises a VDP (Video Display Processor) for generating image data based on the control signal outputted from the main CPU 41, a video PAM for temporarily storing image data generated by the VDP, and the like. Further, image data used in generating the image data by the VDP is included in the game program, which is read from the memory card 53 and stored in the RAM 43.

The bill validator 22 not only discriminates a regular bill from a false bill, but also accepts the regular bill into the cabinet 11. The bill validator 22, on accepting the regular bill, outputs an input signal to the main CPU 41 based on a face amount of the bill. The main CPU 41 stores in the RAM 43 the number of credits corresponding to the face amount of the bill transmitted by the input signal.

The ticket printer 35, based on the control signal outputted from the main CPU 41, prints on a ticket a barcode formed by encoding data such as the number of credits stored in the RAM 43, a date, and an identification number of the slot machine 10, and outputs the ticket as the ticket 39 with a barcode.

The card reader 36 reads data from the smart card and transmits it to the main CPU 41, and also writes data into the smart card based on the control signal from the main CPU 41. The key switch 38S is provided on the key pad 38, and outputs a predetermined input signal to the main CPU 41 when the key pad 38 is operated by the player. The data display device 37 displays data read by the card reader 36 and data inputted by the player through the key pad 38 based on the control signal outputted from the main CPU 41.

The door PCB 80 is connected with a control panel 20, a reverter 21S, a coin counter 21C and a cold cathode tube 81. The control panel 20 is provided with a start switch 23S corresponding to the spin button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. The start switch 23S outputs, to the CPU 41, a signal indicating that a game starts, when the spin button 23 is pressed. The respective switches 23S to 27S output input signals to the main CPU 41 when each of the buttons 23 to 27 corresponding thereto is operated by the player.

The coin counter 21C is provided inside the coin receiving slot 21, and discriminates a regular coin from a false coin inserted into the coin receiving slot 21 by the player. Coins other than the regular coin are discharged from the coin payout exit 19. Further, the coin counter 21C, on detecting the regular coin, outputs an input signal to the main CPU 41.

The reverter 21S operates based on the control signal outputted from the main CPU 41, and distributes the coin recognized as the regular coin by the coin counter 21C into a cash box (not illustrated) or the hopper 66, which are disposed in the slot machine 10. Namely, when the hopper 66 is filled with coins, the regular coin is distributed into the cash box by the reverter 21S. On the other hand, when the hopper 66 is not filled with coins, the regular coin is distributed into the hopper 66. The cold cathode tube 81 functions as a back light installed on the rear face side of the lower image display panel 16 and the upper image display panel 33, and is lighted based on the control signal outputted from the main CPU 41.

Next, there will be described processing which is conducted by the mother board 40. The game execution processing has been already described with reference to FIG. 1 and will not be described here.

First, the mini-game execution processing which is conducted in step S110 in FIG. 1 will be described. Hereinafter, there will be described a case where Poker and Baccarat are executed as mini games.

FIG. 9 is a flow chart illustrating a subroutine of the mini-game execution processing in a case where Poker is executed as the mini game.

In Poker according to the present embodiment, five cards are dealt to the player, and a choice of Hold or Change is accepted for each card. Then, cards are exchanged based on the choice, and the point value is offered to the player based on the hand established by the five cards after the exchange.

At first, in step S201, the main CPU 41 determines five cards to be dealt to the player out of a single set of playing cards, using random numbers.

Next, in step S202, the main CPU 41 displays, to the lower image display panel 16, card images indicating the five cards determined in step S201 (see FIG. 5).

Next, in step S203, the main CPU 41 detects inputs of Hold and Change from the Hold button 92 and the Change button 93.

Next, in step S204, the main CPU 41 updates the cards, based on the result of the detection in step S203. Namely, the card for which Hold has been selected is kept displayed, while the card for which Change has been selected is exchanged with the different card.

Next, in step S205, the main CPU 41 determines the hand established after the exchange of cards.

Next, in step S206, the main CPU 41 determines the point value to be offered to the player, based on the hand determined in step S205. More specifically, when Royal Flush is established, 50 points corresponding to the upper limit are offered. When Straight Flush is established, 45 points are offered. When Four of a Kind is established, 40 points are offered. When Full House is established, 30 points are offered. When Flush is established, 20 points are offered. When the hand other than the above-mentioned hands is established, 10 points are offered.

Next, in step S207, the main CPU 41 stores, in the RAM 43, the point value determined in step S206.

Next, in step S208, the main CPU 41 displays the result of the mini game to the lower image display panel 16. More specifically, the main CPU 41 displays, to the lower image display panel 16, an image indicating the name of the established hand and the point value to be offered to the player.

After conducting the processing in step S208, the main CPU 41 ends the present subroutine.

FIG. 10 is a flow chart illustrating a subroutine of the mini-game execution processing in a case where Baccarat is executed as the mini game.

In Baccarat according to the present embodiment, the BET placed on the game between “PLAYER” and “BANKER” is accepted. Namely, the player places a BET on one of the following results: the win of “PLAYER,” the win of “BANKER,” and “DRAW.” The game played between “PLAYER” and “BANKER” is as follows. Namely, two playing cards are dealt to each of “PLAYER” and “BANKER,” and either of them having a total sum of the ranks drawn on the two cards, with the last digit closer to nine compared to the other, is determined to be a winner. Based on the result of the game and the BET, the point value is offered.

In step S301, the main CPU 41 determines whether or not the BET has been inputted. Namely, the main CPU 41 determines whether or not the BET has been inputted through the operations of the BET buttons 106, the “PLAYER” button 107, the “BANKER” button 108, and the “DRAW” button 109. When determining that no BET has been inputted, the main CPU 41 returns the processing to step S301.

On the other hand, when determining that the BET has been inputted, in step S302, the main CPU 41 determines two cards to be dealt to each of “PLAYER” and “BANKER” out of a single set of playing cards, using random numbers.

Next, in step S303, the main CPU 41 displays, to the lower image display panel 16, card images indicative of the cards determined in step S302 (see FIG. 6).

Next, in step S304, the main CPU 41 conducts a processing to compare the sum of the ranks drawn on the two cards dealt to “PLAYER” with the sum of the ranks drawn on the two cards dealt to “BANKER,” so as to determine either of them having the sum with the last digit closer to nine compared to the other, to be a winner.

Next, in step S305, the main CPU 41 determines the point value to be offered to the player, based on the result of the processing in step S304. More specifically, when the player has placed the BET on “PLAYER” and “PLAYER” wins, the main CPU 41 determines that the point value which is twice the number of BETs should be offered. When the player has placed the BET on “BANKER” and “BANKER” wins, the main CPU 41 determines that the point value which is twice the number of BETs should be offered. When the player has placed the BET on “DRAW” and the game results in a draw, then the main CPU 41 determines that the point value which is three times the number of BETs should be offered. In a case other than the above-mentioned cases, the main CPU 41 determines that the point value to be offered is zero. Further, when the point value calculated based on the number of BETs exceeds the upper limit value of sixty, sixty points are offered regardless of the number of BETs.

Next, in step S306, the main CPU 41 stores, in the RAM 43, the point value determined in step S305.

Next, in step S307, the main CPU 41 displays the result of the mini game to the lower image display panel 16. More specifically, the main CPU 41 displays, to the lower image display panel 16, an image indicating whether or not the player has won the bet and an image indicating the point value to be offered.

After conducting the processing in step S307, the main CPU 41 ends the present subroutine.

FIG. 11 is a flow chart illustrating a subroutine of the bonus-game execution processing which is conducted in step S111 in FIG. 1.

First, in step S401, the main CPU 41 determines whether or not the point value to be consumed (hereinafter, also referred to as a to-be-consumed point value) has been inputted. Namely, the main CPU 41 determines whether or not an input for setting the point value to be consumed by the player has been performed through the key pad 38.

When determining that the to-be-consumed point value has been inputted, the main CPU 41 conducts, in step S402, processing for subtracting the to-be-consumed point value from the point value stored in the RAM 43.

When conducting the processing in step S402 or when determining in step S401 that the input of the to-be-consumed point value has not been performed (or the to-be-consumed point value of zero has been inputted), the main CPU 44 determines the number “T” of free games to be executed in step S403.

In the present embodiment, the number of free games which can be played without consuming the point value (hereinafter, also referred to as the basic number of free games) is set to five. Namely, when the to-be-consumed point value is zero, the number “T” of free games is five. The number of free games is increased by ten per one point consumed by the player from the basic number of free games. For example, when ten points are consumed, the number “T” of free games is set to 105.

Next, in step S404, the main CPU 41 conducts symbol determination processing. In this symbol determination processing, the main CPU 41 executes the symbol determination program stored in the RAM 43 to determine the code Nos. of symbols in stopping. Thereby, the combination of symbols to be rearranged is determined. This processing will be specifically described later with reference to FIG. 13.

Next, in step S405, the main CPU 41 conducts scrolling-display control processing.

This processing is processing for starting scrolling display of symbols and then stopping the scrolling display in the respective display blocks 28 such that the combination of symbols determined in step S404 is rearranged along the winning line L.

Next, the main CPU 41 determines whether or not the prize has been established in step S406. When determining that the prize has been established, the main CPU 41 pays out coins according to the number of coin-ins and the prize (step S407).

Here, there will be described the prize in the bonus game according to the present embodiment.

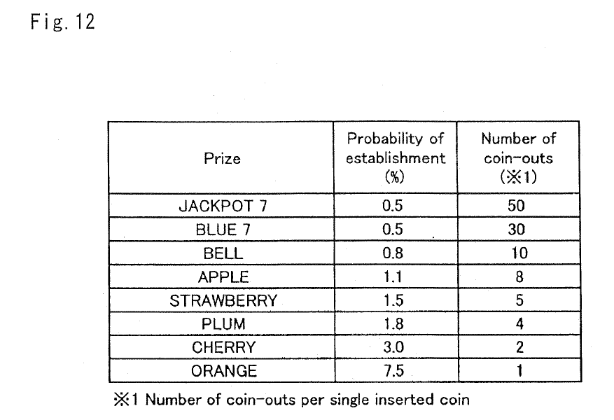

FIG. 12 is a view for explaining the relationship among a plurality of types of prizes, the probabilities of establishment of the respective prizes, and the numbers of coin-outs for the respective prizes, in the bonus game according to the present embodiment.

When five symbols of “JACKPOT 7” are rearranged along the winning line L, fifty coins are paid out per single inserted coin. Similarly, when five same symbols of “BLUE 7,” “BELL,” “STRAWBERRY,” “PLUM,” “CHERRY,” or “ORANGE” are rearranged along the winning line L, coins in number corresponding to the prize for each combination are paid out.

When conducting the processing in step S407, or when determining, in step S406, that no prize has been established (when determining that no-winning has occurred), the main CPU 41 determines whether or not the to-be-consumed point value has been added in step S408. Namely, the main CPU 41 determines whether or not an additional input of the to-be-consumed point value has been performed through the key pad 38. When determining that no to-be-consumed point value has been added, the main CPU 41 returns the processing to step S411.

On the other hand, when determining that the to-be-consumed point value has been added, in step S409, the main CPU 41 conducts the processing for performing a subtraction on the point value stored in the RAM 43, and then determines the number “t” of free games to be additionally executed. In this processing, the main CPU 41 determines the value of “t” regarding the number of additional free games per additional one point value is ten.

Next, in step S410, the main CPU 41 conducts processing for adding the value of “t” determined in step S409 to the value of “T.”

Next, in step S411, the main CPU 41 conducts processing for subtracting one from the value of “T.”

Next, in step S412, the main CPU 41 determines whether or not the value of “T” is zero. When determining that the value of “T” is not zero, the main CPU 41 returns the processing to step S404.

On the other hand, when determining that the value of “T” is zero, the main CPU 41 clears the point value stored in the RAM 43 and ends the present subroutine.

The processing for conducting steps S404 to S412 is processing for executing the free game. The free game corresponds to a unit game according to the present invention.

FIG. 13 is a flow chart illustrating a subroutine of the symbol determination processing which is conducted in step S104 in FIG. 1 and in step S404 in FIG. 11. This processing is processing conducted through the execution, by the main CPU 41, of the symbol determination program stored in the RAM 43.

First, the main CPU 41 executes a random-number generation program included in the symbol determination program, to select random numbers corresponding to the respective symbol columns, out of a numerical range from 0 to 255 (step S501). In the present embodiment, there will be described a case where random numbers are generated on the program (in a case where so-called software random numbers are used). However, in the present invention, a random-number generator may be provided, and random numbers may be extracted from this random-number generator (so-called hardware random numbers may be used).

Next, the main CPU 41 determines code Nos. for the respective symbol columns (see FIG. 7) based on the selected five random numbers (step S502). The code Nos. for the symbol columns correspond to the code Nos. for symbols which are to be rearranged along the winning line L. The main CPU 41 determines the prize by determining code Nos. for the respective symbol columns. For example, when the main CPU 41 determines the code Nos. for the respective symbols to be “00,” “00,” “00,” “00,” and “00,” this indicates that the main CPU 41 determines “JACKPOT 7” as the prize.

After conducting the processing in step S502, the main CPU 41 ends the present subroutine.

As described above, the slot machine 10 according to the present embodiment is provided with the lower image display panel 16 (the display) capable of arranging symbols thereto. Further, the slot machine 10 is provided with the mother board 40 (the controller) programmed to conduct the processing of (a) executing a normal game in which a game medium may be offered and the above-mentioned symbols are rearranged to the above-mentioned lower image display panel 16; (b) executing the bonus game comprised of a single or a plurality of free games in which the above-mentioned symbols are rearranged to the above-mentioned lower image display panel 16, the bonus game is a game more advantageous to the player compared to the above-mentioned normal game; (c) executing a mini game corresponding to the above-mentioned symbols rearranged, out of a plurality of types of mini games in which the point value may be offered; and (d) increasing, in a case where the point value is consumed, the number of executions of the free games in the bonus game.

In the present embodiment, there has been described a case where five types of games as illustrated in FIG. 2 are associated with symbols as mini games. However, the type of the mini game according to the present invention is not limited to five types, provided that a plurality of types of games is provided.

Further, while in the present embodiment, there has been described a case where the card game is executed as the mini game, the type of the mini game according to the present invention is not limited to the card game. Examples thereof may include a slot machine game and a video roulette game.

Further, while in the present embodiment, there has been described a case where the upper limit value of the point value which may be offered in the mini game is different in each mini game, in the present invention, the upper limit value may be the same in a plurality of types of mini games. Also, in the present invention, an upper limit is not particularly required to be set on the point value which may be offered in the mini game.

Further, the mini game according to the present invention is not particularly limited, provided that the mini game is a game in which a point value may be offered. However, it is preferable that the mini game according to the present invention is a game in which no point value can be consumed.

Further, while in the present embodiment, there has been described a case where the mini game is generated during the execution of the normal game, in the present invention, the mini game may be generated during the execution of the bonus game.

While in the present invention, there has been described a case where the number of free games offered per unit to-be-consumed point value is constant (ten games), in the present invention, the number of unit games offered per unit to-be-consumed point value may be configured to be increased with an increase of the to-be-consumed point value. An example thereof may include a case where the number of free games is configured to increase exponentially with the to-be-consumed point value.

Further, while in the present embodiment, it is possible to play a predetermined number of free games (five free games) even when the to-be-consumed point value is zero, in the present invention, it may be configured such that no unit game can be executed when the to-be-consumed point value is zero.

Further, in the present embodiment, there has been described a case where a game comprised of a free game (slot machine game) is executed as the bonus game, the free game is more advantageous to the player compared to the normal game in that it is possible to play without consuming the game medium. However, the bonus game according to the present invention is not particularly limited, provided that the bonus game is a game which is more advantageous to the player compared to the normal game (for example, a game in which a greater amount of game media may be paid out per unit time compared to the normal game) and is capable of consuming the point value. However, it is preferable that the bonus game according to the present invention is a game in which no point value is offered.

Further, in the present embodiment, there has been described a case where it is possible to additionally input the point value to be consumed is inputted (step S408 in FIG. 11), after the point value to be consumed is once inputted (steps S401 and S402 in FIG. 11). However, in the present invention, it may be configured such that it impossible to add the point value to be consumed in that bonus game, once the point value to be consumed is inputted.

Further, in the present embodiment, there has been described a case where the number of executions of the free game constituting the bonus game is determined according to the consumed point value. However, in the present invention, the execution time period of the bonus game may be determined according to the consumed point value (for example, one minute for the consumption of one point, and four minutes for the consumption of two points).

While in the present embodiment, the point value offered in the mini game is stored in the RAM 43 included in the slot machine 10, in the present invention, the point value offered in the mini game may be stored in a storage medium (for example, an IC card and a magnetic stripe card) carried by the player or in an external management device (for example, a control server) which is communicably connected to the slot machine through a communication line.

Further, in the present embodiment, there has been described a case where the symbol used in determining the type of the mini game to be executed is also used in determining the prize in the normal game and the bonus game. However, in the present invention, the symbol used in determining the type of the mini game to be executed may be different from the symbol used in determining the prize in the normal game and the bonus game. Also, symbols may be used only in determining the type of the mini game to be executed, not in the normal game and the bonus game.

Although the present invention has been described with reference to embodiments thereof, these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processes to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A slot machine comprising:
a display capable of arranging symbols thereto; and
a controller,
said controller programmed to conduct the processing of:
(a) executing a normal game in which a game medium may be offered and said symbols are rearranged to said display;
(b) executing a bonus game comprised of a single or a plurality of unit games in which said symbols are rearranged to said display, said bonus game is a game more advantageous to a player compared to said normal game;
(c) executing a mini game corresponding to said symbols rearranged, out of a plurality of types of mini games in which a point value may be offered; and
(d) increasing, in a case where said point value is consumed, an execution time period of said bonus game or the number of executions of said unit game in said bonus game.

2. The slot machine according to claim 1,
wherein
said processing (c) is a processing of:
executing said mini game corresponding to said symbols rearranged in said normal game, out of said plurality of types of mini games.

3. The slot machine according to claim 1,
wherein
said processing (c) is a processing of:
executing said mini game corresponding to said symbols rearranged in said unit game in said bonus game, out of said plurality of types of mini games.

4. The slot machine according to claim 1,
wherein
said processing (c) is a processing of:
executing a card game corresponding to said symbols rearranged, out of said plurality of types of card games in which said point value may be offered.

5. The slot machine according to claim 1,
wherein
said processing (c) is a processing of:
executing said mini game corresponding to said symbols rearranged, out of a plurality of types of said mini games, each of which having a different upper limit of an amount of said point value which may be offered.

6. The slot machine according to claim 1,
wherein
said processing (d) is a processing of:
increasing, in a case where said point value is consumed, the execution time period of said bonus game or the number of executions of said unit games in said bonus game, according to the amount of said consumed point value.
